(19) United States
(12) Patent Application Publication
(10) Pub. No.: US 2011/0242580 A1
(43) Pub. Date: Oct. 6, 2011

(54) SUBMISSION OF JDF PRINT JOBS TO A TARGET PRINTER USING A USB STORAGE DEVICE AND OTHER RELATED METHODS

(75) Inventor: John Phuong TRAN, Garden Grove, CA (US)

(73) Assignee: KONICA MINOLTA SYSTEMS LABORATORY, INC., Huntington Beach, CA (US)

(21) Appl. No.: 12/751,867

(22) Filed: Mar. 31, 2010

(51) Int. Cl. G06F 3/12

(52) U.S. Cl. 358/1.15

(57) ABSTRACT

A method for submitting a Job Description Format (JDF) print job to a printer using a USB flash drive or other portable storage device is described. An operator stores JDF files on the USB drive, and inserts it in the printer. The printer detects the USB drive, identifies the JDF files, and displays a list of the JDF files on a control panel of the printer for the operator to select a JDF file. The printer reads and interprets the selected JDF file to obtain job parameters, and displays the job parameters on the control panel. If desired, the operator modifies the job parameters using the control panel. The printer prints the print job according to the modified job parameters, and saves the modified job parameters back to the USB drive. Additional functions, such as updating audit information in the JDF file and displaying operator instructions, may be provided.

### BACKGROUND OF THE INVENTION

1. Field of the Invention

This invention relates to handling of JDF print jobs, and in particular, it relates to a method of submitting JDF print jobs to a target printer using a portable storage device such as a USB storage device.

2. Description of Related Art

In an environment where a large number of print jobs are processed with multiple printers, there has been a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application. Typically, each printing job specifies a source file that electrically contains a document to be printed, the size, color and the type of the paper on which the document should be printed, the printing resolution, duplex or single-side printing, and certain finishing conditions, such as book, staple, collate printing, etc., depending on a print job requester's needs.

In order to process a large volume of print jobs that each differ in terms of these job parameters, a print shop utilizes multiple commercial grade printers, including black & white and color printers. Each of these printers has limitations on available printer settings, such as the paper size, the paper type, resolution settings, etc. In addition, the print shop employs various finishing devices, such as collators, staplers, hole punchers, folding machines, binding machines, etc. A print shop management system (or print job management system) is typically implemented by software or firmware programs executed by a print shop management apparatus such as a control computer or server connected to the printers. The print shop management system submits each print job to one or more printers and finishing devices to produce the print job. The job submission may be done automatically by the print shop management system, semi-automatically with certain amount of operator intervention, or manually where decisions of how to submit the print job to appropriate printers or finishing devices are made by an operator.

Job Description Format (JDF) is a technical standard developed by the printing and other industries to facilitate cross-vendor workflow implementations of printer applications. It is an Extensible Markup Language (XML)-based format for printing work order files, often referred to as “job tickets”. The current version of JDF is described in JDF Specification, Release 1.4a, Dec. 17, 2009.

A JDF job ticket provides JDF elements required to specify printing parameters associated with the printing of a particular job. The JDF elements are organized as a hierarchical “tree” structure such that various parameters are grouped into associated, logical “branches” of the tree of possible parameters and options. The tree structure has a common “root” and branches are associated with certain enumerated groupings of related parameters that may be specified by a user/application in creating a job ticket. Many printing systems now have a print server or other control devices for receiving a JDF job ticket and processing the JDF elements specified therein to directly control aspects of processing a print job.

JDF provides three primary benefits to the printing industry: (1) the ability to unify the prepress, press and post-press aspects of any printing Job, unlike any previous format; (2) the means to bridge the communication gap between production services and Management Information Systems (MIS); and (3) the ability to carry out both of these functions no matter what system architecture is already in place and no matter what tools are being used to complete the Job. JDF provides a versatile and comprehensive interchange data format to be used by a system of administrative and implementation-oriented components, which together produce printed products. It provides the means to describe print jobs in terms of the products eventually to be created, as well as in terms of the processes needed to create those products. The format provides a mechanism to explicitly specify the controls needed by each process, which may be specific to the printers that will execute the processes.

Various methods can be used to submit JDF print jobs to target printers. One such method is drag-and-drop, where the operator drags and drops a JDF file into a “hot folder” specifically designed for submitting JDF job to a particular printer. Another method uses a JDF job submission utility, such as Alces, or a print workflow application program of a print shop management server. To implement these JDF submission methods, device configuration information regarding the target device (e.g., a printer) is often required. Device configuration information includes information regarding the capabilities and various settings of the target device. Without the device configuration info, a user often does not know how to submit a JDF job to the target device.

Printing directly from a portable data storage device is known. For example, U.S. Pat. No. 7,489,417 describes a system and interface wherein a multifuntion printer/copier, equipped with a Universal Serial Bus port, accepts data directly from a USB-Data Storage Device for the purpose of printing, e-mailing, and faxing. The data files stored on the USB storage device are in their native application format from which they were generated, such as Word, Excel, PDF, PowerPoint, AutoCAD and the like, and the multifuntion printer/copier has a document conversion utility that convert these documents into a postscript format for printing.

### SUMMARY

The present invention is directed to a method and related apparatus for JDF print job submission that substantially obviates one or more of the problems due to limitations and disadvantages of the related art.

An object of the present invention is to enable a user to submit JDF jobs by storing JDF files on a portable storage device such as a USB (Universal Serial Bus) storage device, and inserting the portable storage device into a peripheral port such as a USB port of the target device.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method performed by a printer for processing a Job Description Format (JDF) print job submission, which includes: (a) detecting a portable storage device received by a peripheral port of the printer, the portable storage device storing at least one JDF file, each JDF file defining a print job; (b) identifying the at least one JDF file stored in the portable storage device and displaying a list of the at least one JDF files on a control panel of the printer; (c) receiving an operator input via the control panel which specifies a selected one of the at least one JDF files; (d) reading and interpreting a content of the selected JDF file to obtain a plurality of job parameters; and (e) printing the print job according to the job parameters.

The method may additionally include: displaying the plurality of job parameters on the control panel; and receiving an operator input via the control panel which specifies a modification of at least one of the job parameters, wherein in step (e), the print job is printed according to the modified job parameters. The method may further include saving the modified job parameters to the portable storage devise, either by generating a new JDF file or by modifying the selected JDF file previously stored in the portable storage device.

In another aspect, the present invention provides a printer having a control section which includes a memory for storing computer readable program code and a processor executing the code to control the printer, the computer readable program code being configured to cause the printer to execute a process for processing a Job Description Format (JDF) print job submission, wherein the process includes the steps summarized in the two preceding paragraphs.

In another aspect, the present invention provides a method for submitting a Job Description Format (JDF) print job to a printer, which includes: an operator storing at least one JDF file on a portable storage device, each JDF file defining a print job; the operator inserting the portable storage device in the printer; the printer detecting the portable storage device, identifying the at least one JDF file stored in the portable storage device, and displaying a list of the at least one JDF files on a control panel of the printer; the operator selecting one of the at least one JDF files via the control panel; the printer reading and interpreting a content of the selected JDF file to obtain a plurality of job parameters; the printer displaying the plurality of job parameters on the control panel; the operator modifying at least one of the job parameters via the control panel; the printer printing the print job according to the modified job parameters; and the printer saving the modified job parameters to the portable storage devise, either by generating a new JDF file or by modifying the selected JDF file previously stored in the portable storage device.

In another aspect, the present invention provides a method for generating a Job Description Format (JDF) file using a printer, which includes: an operator inserting a portable storage device in the printer; the operator specifying a plurality of print job parameters using a control panel of the printer; the printer generating a JDF file based on the job parameters specified by the operator; and the printer saves the JDF file on the portable storage device.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a method for submitting a JDF job to a target printer using a USB flash drive according to an embodiment of the present invention.

FIGS. 2A-2C illustrates examples of display screens displayed by the printer during the JDF job submission process of FIG. 1.

FIG. 3 schematically illustrates a method for creating a JDF file using a printer and saving the JDF file to a USB flash drive according to another embodiment of the present invention.

FIGS. 4A-4C illustrate examples of a display screen displayed by the printer during the JDF file creating process of FIG. 3.

FIG. 5 schematically illustrates a system including a printer in which embodiments of the present invention may be implemented.

### DETAILED DESCRIPTION OF PREFERRED EMBODIMENTS

Embodiments of the present invention provides a method that allows a print shop operator to submit JDF job to a target device (e.g., printer, finishing device, or other device) by storing JDF files on a portable storage device (e.g., a USB storage device) and inserting the portable storage device into a peripheral port of the target device. The target device reads the JDF files and carries out desired functions as directed by the operator. In the descriptions below, a printer is used as an example of the target device.

The portable storage devices useful in implementing the present invention include USB flash drives, memory cards, CD/DVD, or other suitable storage devices. In the descriptions below, a USB flash drive is used as an example.

FIG. 5 is a schematic block diagram showing an exemplary printing system in which embodiments of the present invention may be implemented. The printing system comprises a printer 20 connected to a data communication line 30, such as a network (wired or wireless). The communication line 30 may also be a serial bus or a dedicated cable connected to the printer. A server 40 and/or other components such as mass storage device, etc. are also connected to the network 30. The system also includes a computer 10, which may or may not be connected to the network 30. The computer 10 has a structure commonly known in the art and is equipped with software applications for creating JDF files. The computer 10 also has a peripheral port, such as a USB port, for receiving a peripheral device such as a USB storage device.

The printer 20 includes a controller or control section 21, an image processing section 22, a print engine 23, and an input/output (I/O) section 24. The control section 21 controls the other internal sections of the printer 20. The control section 21 and the image processing section 22 also processes data received from an external device (e.g. the server 40) for printing by the print engine 23. The I/O section 24 receives print data from external devices such as the server 40 and communicates with external devices via the network 30.

The printer 20 also has an operator control panel 25 accessible by an operator. The control panel 24 includes a display such as an LCD screen and user input means such as keys, buttons, touch screen, etc. An operator can use the control panel 25 to communicate with and control the printer. In addition, the printer 20 is equipped with a peripheral port 26, such as a USB port, for receiving a peripheral device such as a USB storage device.

Methods for printing JDF jobs according to embodiments of the present invention may be implemented in the printer 20 by software or firmware executed by the control section 21.

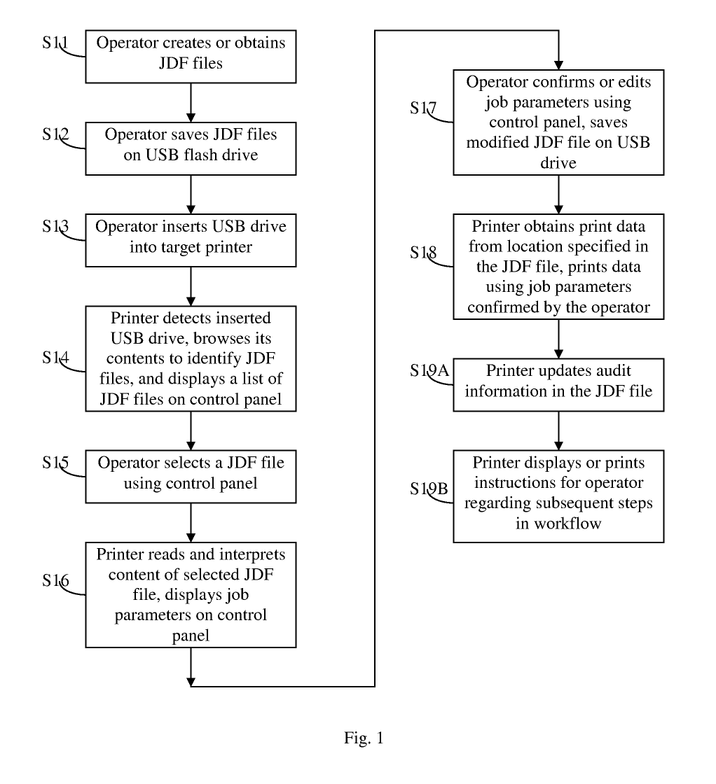

FIG. 1 illustrates a JDF job submission method using a USB flash drive (or other portable storage device) according to an embodiment of the present invention. First, the operator creates or obtains a JDF file on a computer 10 (step S11). The computer 10 is separate device from the target printer, and can be either connected to the network 30 or not connected to the network 30. The operator may create the JDF file from scratch by specifying the job requirements, for example, by using a utility program. A JDF file may also be created by converting a job ticket in another format to a JDF file, or by extracting an exported job ticket from a utility program. The operator may also obtain the JDF file from another computer. A JDF file typically does not contain the actual print data; rather, it typically contains a description of a location of the print data, such as a network address (e.g. an URL). The target printer will obtain the print data from the specified location, and prints the print data using the job ticket settings specified in the JDF file.

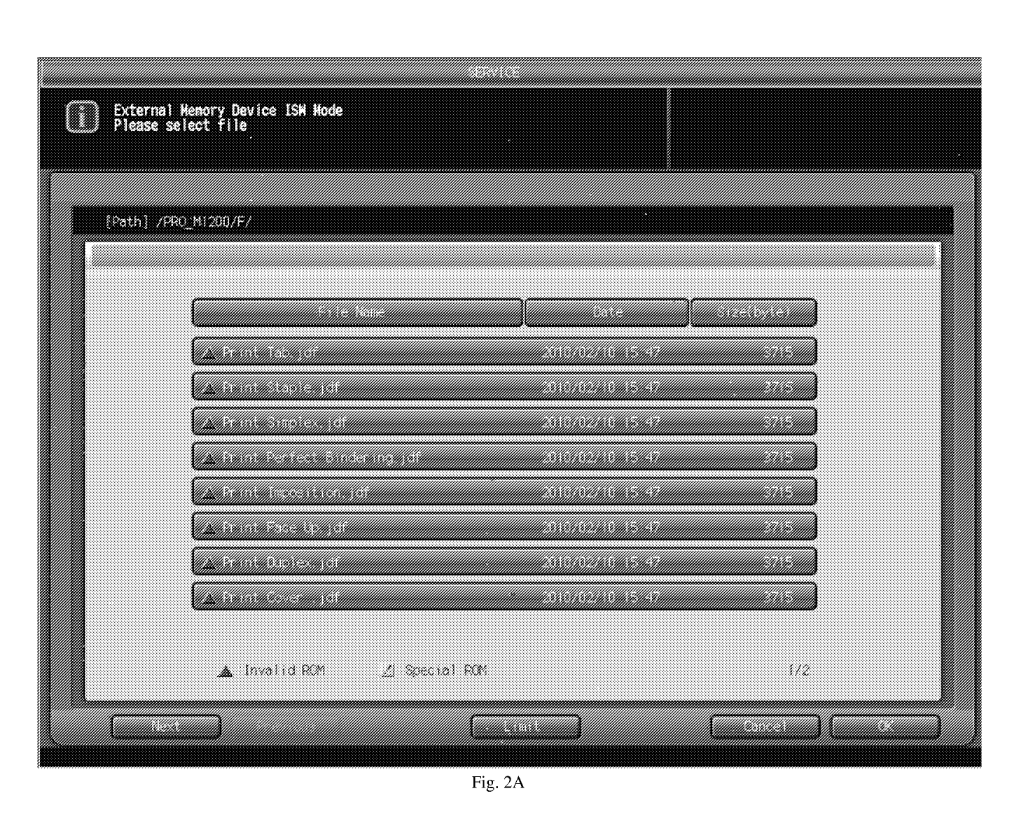

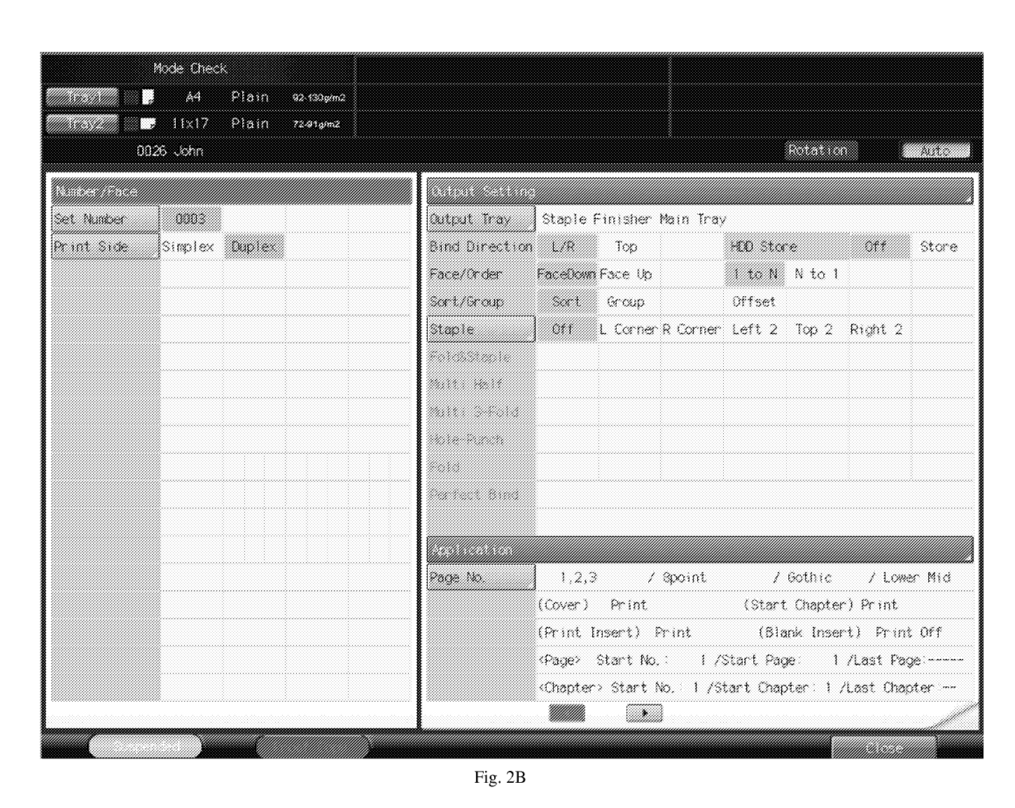

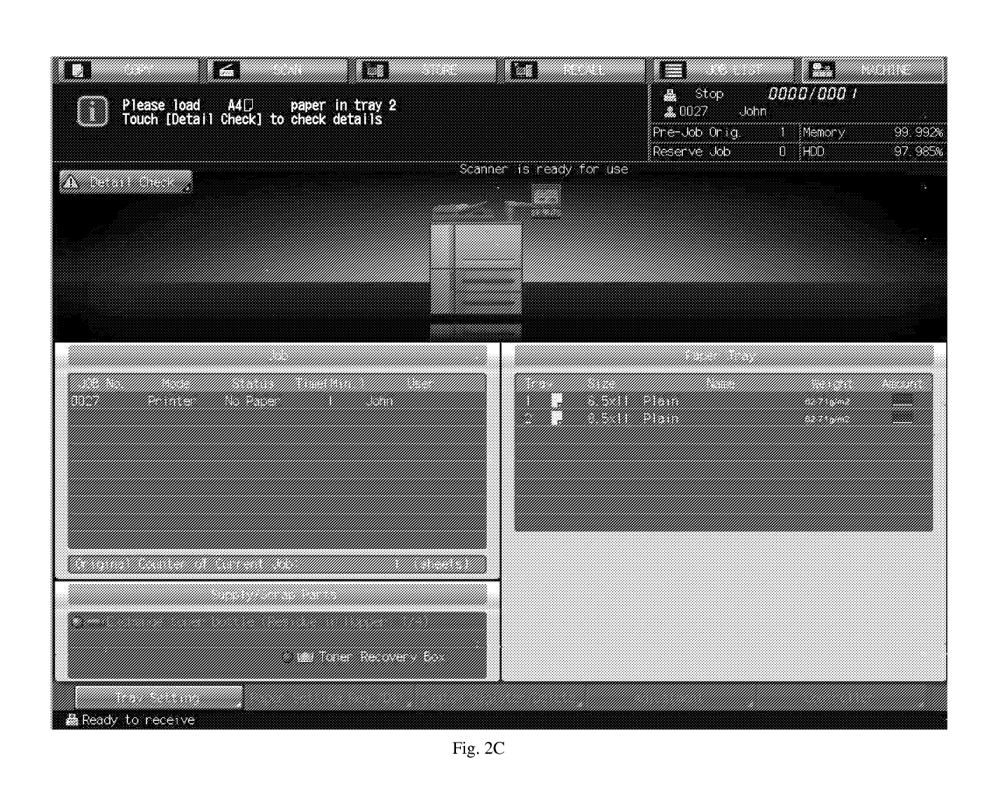

The operator saves one or more JDF files on a USB drive (step S12), and then inserts the USB drive into the peripheral port 26 of the target printer 20 (step S13). The printer detects that a USB drive has been inserted, and browses its content to identify JDF files (step S14). JDF files may be identified by their filename extension “.jdf”. The printer displays a list of JDF files found on the USB drive using the control panel 25 on the printer (step S14). FIG. 2A illustrates an exemplary display screen on the control panel which displays a list of JDF files found on the USB drive. Step S14 is preferably performed automatically by the printer 20 without the operator's initiation.

The operator, who is physically located at the printer, selects one of the JDF files using the user input means of the control panel 25 (step S15). In the example shown in FIG. 2A, the display screen of the control panel is a touch screen, and the operator can select a JDF file by touching it on the screen. The printer reads and interprets the content of the selected JDF file, and displays the job parameters obtained from the JDF file on the control panel 25 (step S16). The job parameters are preferably displayed in a format that is easy to comprehend by the operator. FIG. 2B illustrates an exemplary display screen on the control panel which displays job parameters read from the JDF file.

As a part of step S16, the printer checks the JDF file content to determine if it is correctly formatted or not. If it is not correctly formatted, the printer displays a warning message to alert the operator, so that the operator may select a different JDF file.

In addition, as a part of step S16, the printer compares the job parameters specified in the JDF file with the capabilities of the printer. If a job parameter specified in the JDF file is inconsistent with the capabilities of the printer (i.e., if the job parameter is unsupported or mismatched), the printer displays an indication to this effect on the display. For example, if the job parameter in the JDF file specifies A4 as the paper size, but the printer only has letter sized paper in its input paper trays, the display will indicate this fact, either by incorporating an appropriate message in the job parameter display screen (not shown in FIG. 2B), or by using a separate display screen such as that shown in FIG. 2C.

The information displayed on the control panel is interactive to allow the operator to easily edit the job parameters using the input means of the control panel. In the example shown in FIGS. 2B and 2C, the display screen of the control panel is a touch screen, and the operator can edit the job parameters by touching the screen. Based on the job parameters displayed on the control panel, the operator may confirm the job parameters or edit them using the input means of the control panel (step S17). In particular, for example, when the display indicates any unsupported or mismatched job parameters, the operator may choose to change the job parameter to the supported value, e.g., changing the paper size parameter to letter size in the above example. Alternatively, if the mismatch can be corrected by changing the printer's settings, for example, if the operator is able to change the paper supply in the input paper tray, the operator may make such corrections and confirm the original job parameters. Note that in the exemplary display shown in FIG. 2C, the screen displays a message instructing the operator to load A4 paper into tray 2. Preferably, the display changes dynamically to reflect such corrections made by the operator.

If editing is made, the operator may choose to save the edited job parameters back to the USB drive for future use (step S17). The operator may choose to either save the edited job parameters as a new JDF file or to overwrite the content of the existing JDF file.

As mentioned earlier, the JDF file typically does not contain the file to be printed (referred to as the print data here), but specifies a location of the file. The location of the print data may be either on a folder on the USB drive itself or a remote location such as an HTTP server located on the network 30. Preferably, the print data should be accessible with no restriction such as password. Once the operator has selected a JDF file in step S15 and confirmed the job parameters in step S17, the printer obtains the print data from the specified location, and prints the data according to the confirmed job parameters (step S18).

The printer may optionally perform one or more of the additional tasks described below.

Updating audit information (step S19A): The printer may update audit information and saved it back to the JDF file on the USB drive. In a JDF file, audit elements contain the post-facto recorded results of a process such as the execution of a JDF node or modification of the JDF itself. Audit information may be used by the MIS (management information system) for operations such as evaluation or invoicing. More details regarding audit may be found in Section 3.11 of the JDF Specification, Release 1.4a, Dec. 17, 2009. The updating of audit information may be performed automatically by the printer without a request by the operator, or it may be performed at the request of the operator. The audit information may be saved by modifying the original JDF file on the USB drive, or by saving a new version of the original JDF file to the USB drive while preserving the original JDF file.

One practical application of audit information update is to facilitate workflow, e.g. processing steps performed by different devices within the print shop. A JDF job may require multiple steps to complete the print job, such as pre-press, printing, finishing, etc. A JDF file may specify the sequence of these steps. Thus, when the printer prints a JDF file, it would be desirable to update the audit information in the JDF file. For example, if a print job requires certain finishing steps that can be performed by the printer (e.g. stapling, when the printer has a stapler) as well as certain finishing steps that must be done by a separate finishing device, the JDF file can be updated to reflect what steps have already been done by the printer. Thus, after the printing step by the printer, the operator can take the USB drive and submit the job to an appropriate finishing device, and the JDF files (having been modified by the printer) will correctly reflect what finishing steps remain to be done by the finishing device.

Providing instructions to the operator regarding subsequent steps required for the job (step S19B): As mentioned above, while the printer carries out the printing step and certain finishing steps, there may be other steps that must be performed by another machine after the printer finishes printing. Thus, the printer may print or display an instruction to the operator regarding the subsequent steps in the workflow. The instruction is produced by analyzing the content of the JDF file read in step S16. The instruction may be displayed on the display of the printer's control panel, of printed as a banner sheet. A banner sheet is a printed sheet that is not a part of the content of the file to be printed, but contains administrative information such as file name and user name as well as any other information useful for the operator. A banner sheet is typically outputted at the top of the pile of sheets printed from the file.

The JDF job submission method described above has many advantages. It provides a simple and convenient way to submit JDF jobs without having to use JDF job submission utility or other print shop management applications. The ability to edit job parameters at the printer allows a JDF job to be corrected submitted to the printer even when the operator does not know all of the correct printer capabilities when initially creating the JDF file on another computer. By allowing the operator to edit the job parameters and save the edited job parameters as JDF files onto the USB drive, the operator can build a collection of JDF files with specific settings compatible with the target printer, and re-use the JDF for future needs. Further, the ability to update the audit information and to print or display instructions regarding subsequent processing steps facilitates automated workflow control. For example, without the printer or displayed instructions, the operator must independently learn what further steps are to be performed and their sequence.

A JDF job submission method using a USB drive is useful in a print shop under many circumstances. For example, in a situation where the computer that initially created the JDF file does not have access to the file to be printer but the printer does have such access, the operator can create the JDF file and transport it to the printer using the USB drive. The ability to generate a JDF file on a separate computer is desirable, for example, when it is inconvenient to use the control panel on the printer for specify complex job parameter settings.

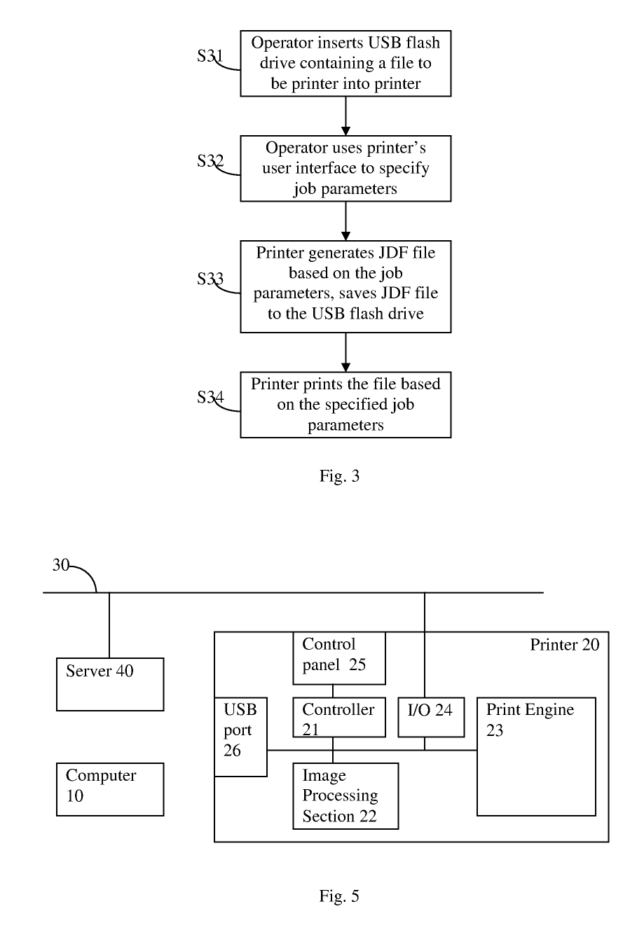

The embodiments described above allows an operator to submit a JDF print job generated on a computer to a target printer using a USB drive or other portable storage devices. Another embodiment of the present invention, shown in FIG. 3, allows an operator to create a JDF file on the printer 20 using the printer's control panel 25, and saves the JDF file to a USB drive of other portable storage device.

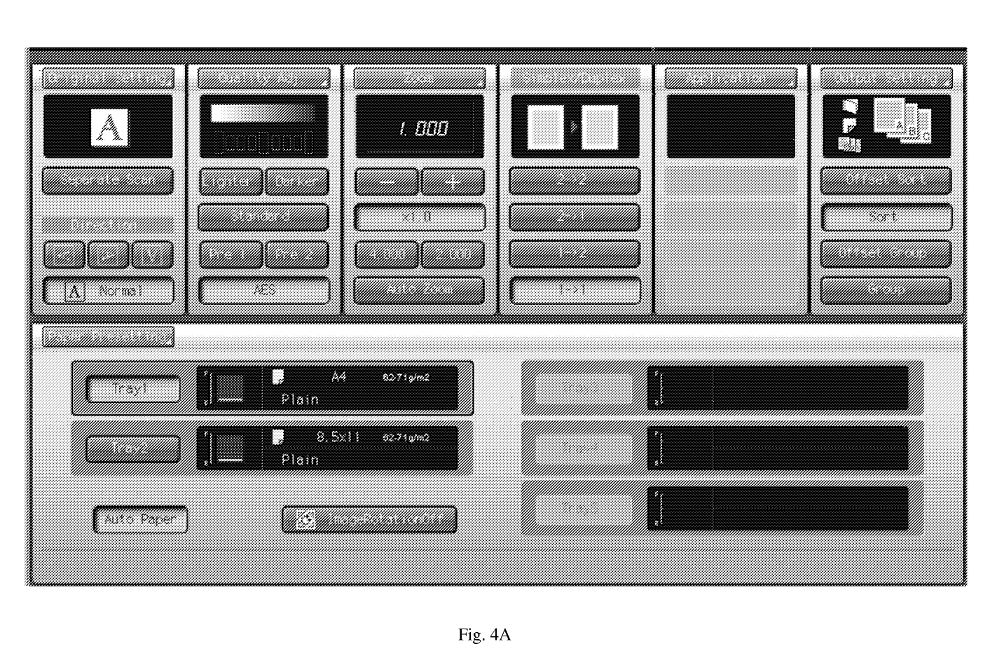

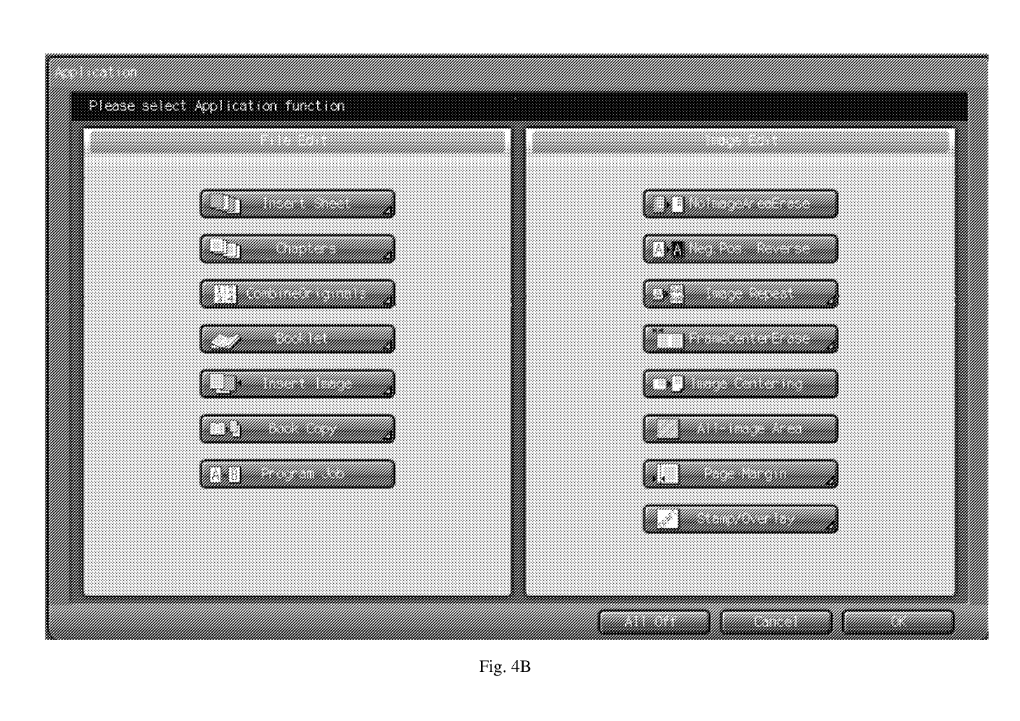

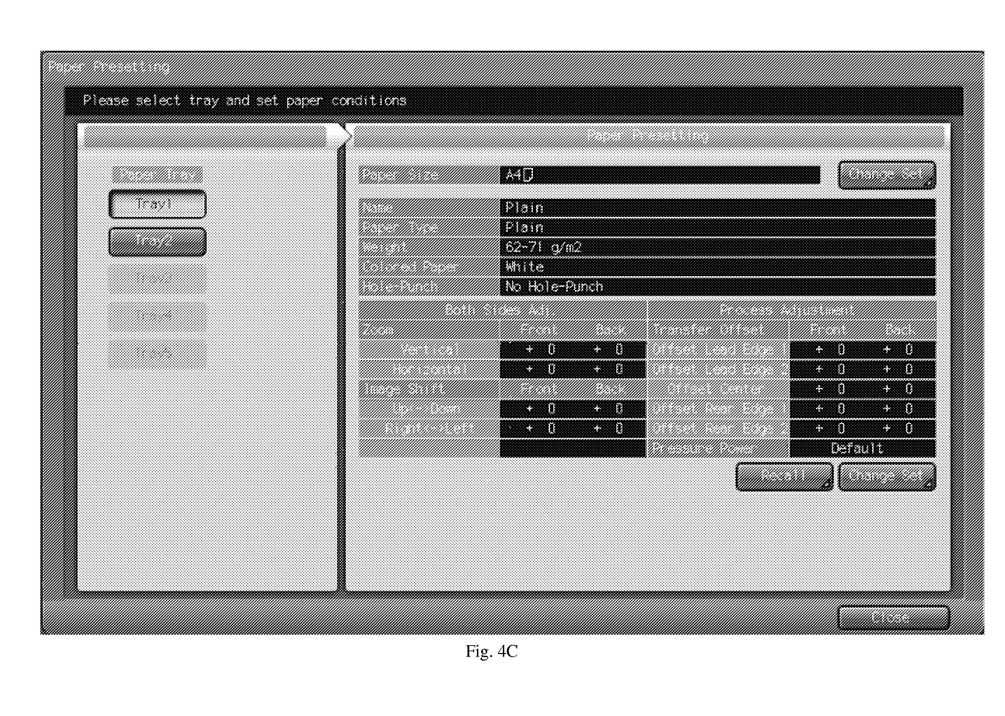

As shown in FIG. 3, the operator inserts a USB drive containing a file to be printed into the printer 20 (step S31). Alternatively, the USB may contain an instruction specifying a location of a file to be printed on another device (computer, database, etc.) accessible by the printer. A conventional printer is typically provided with an interactive user interface (UI) display to allow an operator to specify job parameters for a print job from scratch, i.e., where no job ticket information is supplied from outside of the printer. FIGS. 4A-4C illustrate some examples of such UI display screens. Using such a UI, the operator specifies the job parameters for the print job (step S32). In these examples, the display screen is a touch screen and the operator make selections or enters information using the touch screen.

The printer then generates a JDF file based on the job parameters specified by the operator, and saves the JDF file to the USB drive (step S33). The printer also prints the file using the job parameters specified by the operator (step S34). The printing step S34 is optional; in other words, the operator can create a JDF file and save it to the USB drive without actually printing the file. As another alternative, the USB device does not contain a file to be printed or a file location; the operator simply uses the printer's UI to create a JDF file and save it to an USB drive.

A JDF file generated by the printer as described above may be used to print another file, or used as a template for generating other JDF files. An advantage of this method is that the JDF file (or template) generated this way will contain correct settings compatible with the printer, because the printer's UI will typically only allow the operator to specify job parameters that are supported by this printer.

It will be apparent to those skilled in the art that various modification and variations can be made in the JDF print job submission method of the present invention without departing from the spirit or scope of the invention. Thus, it is intended that the present invention cover modifications and variations that come within the scope of the appended claims and their equivalents.

What is claimed is:

1. A method performed by a printer for processing a Job Description Format (JDF) print job submission, comprising:
(a) detecting a portable storage device received by a peripheral port of the printer, the portable storage device storing at least one JDF file, each JDF file defining a print job;
(b) identifying the at least one JDF file stored in the portable storage device and displaying a list of the at least one JDF files on a control panel of the printer;
(c) receiving an operator input via the control panel which specifies a selected one of the at least one JDF files;
(d) reading and interpreting a content of the selected JDF file to obtain a plurality of job parameters; and
(e) printing the print job according to the job parameters.

2. The method of claim 1, wherein steps (b) is performed automatically without an operator request via the control panel.

3. The method of claim 1, wherein the selected JDF file specifies a file to be printed by specifying a location where the file to be printed is stored, the location being either a folder on the portable storage device or a location on a network connected to the printer, and wherein the method further comprises, prior to step (e),
obtaining the file to be printed from the specified location.

4. The method of claim 1, further comprising, after step (d) and before step (e):
displaying the plurality of job parameters on the control panel; and
receiving an operator input via the control panel which specifies a modification of at least one of the job parameters,
wherein in step (e), the print job is printed according to the modified job parameters.

5. The method of claim 4, further comprising:
saving the modified job parameters to the portable storage devise, either by generating a new JDF file or by modifying the selected JDF file previously stored in the portable storage device.

6. The method of claim 1, further comprising:
automatically updating audit information of the selected JDF file, either by generating a new JDF file containing updated audit information or by modifying the selected JDF file previously stored in the portable storage device.

7. The method of claim 6, wherein the audit information specifies a workflow required for completing the print job.

8. The method of claim 1, further comprising:
displaying on the control panel of the printer, or printing on a banner sheet, instructions regarding any subsequent steps required for completing the print job.

9. A printer comprising:
a control section which includes a memory for storing computer readable program code and a processor executing the code to control the printer, the computer readable program code being configured to cause the printer to execute a process for processing a Job Description Format (JDF) print job submission, wherein the process comprises:
(a) detecting a portable storage device received by a peripheral port of the printer, the portable storage device storing at least one JDF file, each JDF file defining a print job;
(b) identifying the at least one JDF file stored in the portable storage device and displaying a list of the at least one JDF files on a control panel of the printer;
(c) receiving an operator input which specifies a selected one of the at least one JDF files;
(d) reading and interpreting a content of the selected JDF file to obtain a plurality of job parameters; and
(e) printing the print job according to the job parameters.

10. The printer of claim 9, wherein steps (b) is performed automatically without an operator request via the control panel.

11. The printer of claim 9, wherein the selected JDF file specifies a file to be printed by specifying a location where the file to be printed is stored, the location being either a folder on the portable storage device or a location on a network connected to the printer, and wherein the method further comprises, prior to step (e),
obtaining the file to be printed from the specified location.

12. The printer of claim 9, wherein the process further comprises, after step (d) and before step (e):
displaying the plurality of job parameters on the control panel; and
receiving an operator input via the control panel which specifies a modification of at least one of the job parameters,
wherein in step (e), the print job is printed according to the modified job parameters.

13. The printer of claim 12, wherein the process further comprises:
saving the modified job parameters to the portable storage devise, either by generating a new JDF file or by modifying the selected JDF file previously stored in the portable storage device.

14. The printer of claim 9, wherein the process further comprises:
automatically updating audit information of the selected JDF file, either by generating a new JDF file containing updated audit information or by modifying the selected JDF file previously stored in the portable storage device.

15. The printer of claim 14, wherein the audit information specifies a workflow required for completing the print job.

16. The printer of claim 9, wherein the process further comprises:
displaying on the control panel of the printer, or printing on a banner sheet, instructions regarding any subsequent steps required for completing the print job.

17. A method for submitting a Job Description Format (JDF) print job to a printer, comprising:
an operator storing at least one JDF file on a portable storage device, each JDF file defining a print job;
the operator inserting the portable storage device in the printer;
the printer detecting the portable storage device, identifying the at least one JDF file stored in the portable storage device, and displaying a list of the at least one JDF files on a control panel of the printer;
the operator selecting one of the at least one JDF files via the control panel;
the printer reading and interpreting a content of the selected JDF file to obtain a plurality of job parameters;
the printer displaying the plurality of job parameters on the control panel;
the operator modifying at least one of the job parameters via the control panel;
the printer printing the print job according to the modified job parameters; and
the printer saving the modified job parameters to the portable storage devise, either by generating a new JDF file or by modifying the selected JDF file previously stored in the portable storage device.

18. The method of claim 17, further comprising:
the printer updating audit information of the selected JDF file, either by generating a new JDF file containing updated audit information or by modifying the selected JDF file previously stored in the portable storage device.

19. The method of claim 17, further comprising:
the printer displaying on the control panel of the printer, or printing on a banner sheet, instructions regarding any subsequent steps required for completing the print job.

20. A method for generating a Job Description Format (JDF) file using a printer, comprising:
an operator inserting a portable storage device in the printer;
the operator specifying a plurality of print job parameters using a control panel of the printer;
the printer generating a JDF file based on the job parameters specified by the operator; and
the printer saves the JDF file on the portable storage device.
